(19) United States
(12) Patent Application Publication
(10) Pub. No.: US 2004/0007349 A1
(43) Pub. Date: Jan. 15, 2004

(54) Heat exchanger

(75) Inventors: Baek Youn, Suwon-City (KR); Jeung-Hoon Kim, Suwon-City (KR); Young-Saeng Kim, Incheon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon city (KR)

(21) Appl. No.: 10/278,858

(22) Filed: Oct. 24, 2002

(30) Foreign Application Priority Data
Jul. 9, 2002 (KR) 2002-39840

(51) Int. Cl. F28D 1/00; A23C 3/04; F28D 3/02; F28D 7/10

(52) U.S. Cl. 165/115; 165/117; 165/140

(57) ABSTRACT

A heater exchanger used to condense a refrigerant in a refrigeration system. The heat exchanger is designed to perform a heat exchanging operation by the use of latent heat of water vaporization, thus having improved heat exchanging efficiency as well as a reduced size. The heat exchanger includes an upper header having a refrigerant inlet port and distributing a refrigerant introduced into the upper header through the refrigerant inlet port; a plurality of heat exchanging tubes connected at upper ends thereof to the upper header and extending in a vertical direction; a lower header connected to lower ends of the heat exchanging tubes and gathering the refrigerant flowing from the heat exchanging tubes, the lower header having a refrigerant outlet port; and a water supply unit assembled with upper portions of external surfaces of the heat exchanging tubes, and feeding water to the tubes to cause a flow of water along the external surfaces of the tubes, thus allowing the water to absorb heat from the refrigerant flowing in the tubes.

### CROSS-REFERENCE TO RELATED APPLICATIONS

This application claims the benefit of Korean Application No. 2002-39840, filed Jul. 9, 2002, in the Korean Industrial Property Office, the disclosure of which is incorporated herein by reference.

### BACKGROUND OF THE INVENTION

1. Field of the Invention

The present invention relates, in general, to heat exchangers used in refrigeration systems, and more particularly, to a water-cooled heat exchanger used to condense a refrigerant in such a refrigeration system.

2. Description of the Prior Art

As well known to those skilled in the art, a refrigeration system used with air-conditioning apparatuses includes a compressor, a refrigerant-condensing heat exchanger, a refrigerant-expansion unit, and a refrigerant-evaporating heat exchanger, which are sequentially connected to each other by a refrigerant pipe to create a refrigeration circuit. When the compressor of the refrigeration circuit is operated, a refrigerant circulates through the refrigerant pipe while repeatedly changing its phase by transferring heat to or absorbing heat from the surroundings. The refrigerant system thus cools room air.

In such a refrigeration system used with air-conditioning apparatuses, the refrigerant-condensing heat exchanger comprises a refrigerant-distributing header which distributes an outlet refrigerant of the compressor to a plurality of heat exchanging tubes, and a refrigerant-gathering header which gathers the condensed refrigerant flowing from the heat exchanging tubes, prior to feeding the gathered refrigerant to the refrigerant-expansion unit. A plurality of heat exchanging fins having a thin plate shape are assembled with the heat exchanging tubes so as to enlarge the heat exchanging area, at which outdoor air comes into contact with the heat exchanger. During an operation of such a refrigerant-condensing heat exchanger, outdoor air, which is forced by a blower fan installed adjacent to the heat exchanger, cools the tubes and fins, thus condensing the refrigerant flowing in the tubes. The phase of the refrigerant in the refrigerant-condensing heat exchanger is changed from a gas phase into a liquid phase.

However, such a conventional refrigerant-condensing heat exchanger used with refrigeration systems is problematic in that the heat exchanger is cooled only by the air forced by the fan, so the improvement of heat exchanging efficiency is undesirably limited. In addition, the above heat exchanger must have a plurality of heat exchanging fins to enhance the heat exchanging efficiency, so the size of the heat exchanger is undesirably enlarged to accomplish the desired heat exchanging effect. Further, the enlarged size of the heat exchanger undesirably increases the size of a refrigeration system which uses the heat exchanger.

### SUMMARY OF THE INVENTION

Accordingly, it is an object of the present invention to provide a heat exchanger used with refrigeration systems, which has a reduced size and an improved heat exchanging efficiency.

The foregoing and other objects of the present invention are achieved by providing a heat exchanger, comprising: an upper header having a refrigerant inlet port and distributing a refrigerant introduced into the upper header through the refrigerant inlet port; a plurality of heat exchanging tubes connected at upper ends thereof to the upper header and extending in a vertical direction; a lower header connected to lower ends of the heat exchanging tubes and gathering the refrigerant flowing from the heat exchanging tubes, the lower header having a refrigerant outlet port; and a water supply unit assembled with upper portions of external surfaces of the heat exchanging tubes, and feeding water to the tubes to cause a flow of water along the external surfaces of the tubes, thus allowing the water to absorb heat from the refrigerant flowing in the tubes.

Additional objects and advantages of the invention will be set forth in part in the description which follows and, in part, will be obvious from the description, or may be learned by practice of the invention.

In the heat exchanger, the water supply unit comprises a channel which has a water supply port to supply water into the channel, with upper and lower holes formed on upper and lower walls of the water supply unit so as to allow the heat exchanging tubes to pass through the water supply unit, each of the lower holes having a size larger than that of each of the heat exchanging tubes to allow the water to flow from the water supply unit to the external surfaces of the heat exchanging tubes.

In an embodiment, each of the heat exchanging tubes has a circular cross-section, and each of the lower holes of the water supply unit has a polygonal shape, whereby corners of the polygonal lower holes are spaced apart from the external surface of the heat exchanging tubes and edges of the polygonal lower holes are in contact with the external surfaces of the heat exchanging tubes.

In the above heat exchanger, a plurality of support members are projected from an edge of each of the lower holes toward the external surface of an associated heat exchanging tube, thus spacing the external surface of the heat exchanging tube apart from the edge of the lower hole as well as holding the heat exchanging tube without allowing a movement of the tube.

In an embodiment, each of the heat exchanging tubes has a circular cross-section, with a spiral flow guide formed on the external surface of each heat exchanging tube so as to guide a flow of water. In this embodiment, each of the heat exchanging tubes has an inner diameter of 0.7-2.5 mm, and a thickness of about 0.3-1.0 mm.

In another embodiment, each of the heat exchanging tubes has a circular cross-section, with a plurality of linear flow guides axially formed on the external surface of each heat exchanging tube so as to guide a flow of water.

In still another embodiment, the heat exchanging tubes are plate-shaped multi-channel tubes, with a plurality of partitioned refrigerant channels axially formed in each of the heat exchanging tubes. In this embodiment, each of the heat exchanging tubes has a 1.5-2.5 mm thickness, a 5-20 mm width, and a 1.17-1.52 mm diameter of each of the refrigerant channels.

In the heat exchanger, the upper header, lower header and water supply unit respectively comprise a plurality of upper headers, lower headers, and water supply units, which are closely arranged in a parallel arrangement, with the heat exchanging tubes being arranged between the upper headers and the lower headers to create a set of heat exchanger modules.

In an aspect of this embodiment, the heat exchanger further comprises: a refrigerant inlet pipe having a distributing manifold and being connected at the distributing manifold to the refrigerant inlet ports of the upper headers so as to distribute the refrigerant into the upper headers; a refrigerant outlet pipe having a gathering manifold and being connected at the gathering manifold to the refrigerant outlet ports of the lower headers so as to gather the refrigerant from the lower headers; and a water supply pipe having a water distributing manifold, and being connected to water supply ports of the water supply units so as to distribute water into the water supply units.

In addition, a plurality of reinforcing members are assembled with the external surfaces of the heater exchanging tubes at positions between the upper and lower headers, so as to hold the heat exchanging tubes. Each of the reinforcing members is a flat plate, with a plurality of tube passing holes formed on the plate so as to receive the heat exchanging tubes, each of the tube passing holes having a size larger than a cross-sectional size of each of the heat exchanging tubes.

### BRIEF DESCRIPTION OF THE DRAWINGS

These and other objects and advantages of the invention will become apparent and more readily appreciated from the following description of the embodiments, taken in conjunction with the accompanying drawings of which:

FIG. 1 is a perspective view, illustrating the construction of a heat exchanger in accordance with an embodiment of the present invention;

FIG. 2 is a sectional view of the heat exchanger in accordance with an embodiment of the present invention;

FIG. 3 is a sectional view illustrating the construction of the portion “III” of FIG. 2 in detail;

FIG. 4 is a sectional view taken along the line IV-IV′ of FIG. 2;

FIG. 5 is a view corresponding to FIG. 4 illustrating the construction of a heat exchanger in accordance with a modification of the embodiment of FIG. 4;

FIG. 6 is a perspective view illustrating the construction of a heat exchanging tube included in the heat exchanger in accordance with the embodiment of FIG. 1;

FIG. 7 is a view corresponding to FIG. 6 illustrating the construction of a heat exchanging tube in accordance with a modification thereof;

FIG. 8 is a perspective view illustrating the construction of a heat exchanger in accordance with another embodiment of the present invention;

FIG. 9 is a sectional view taken along the line IX-IX′ of FIG. 8;

FIG. 10 is a sectional view taken along the line X-X′ of FIG. 9;

FIG. 11 is a perspective view illustrating the construction of a heat exchanging tube included in the heat exchanger in accordance with the embodiment of FIG. 8; and

FIG. 12 is a view corresponding to FIG. 11 illustrating the construction of a heat exchanging tube in accordance with a modification thereof.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

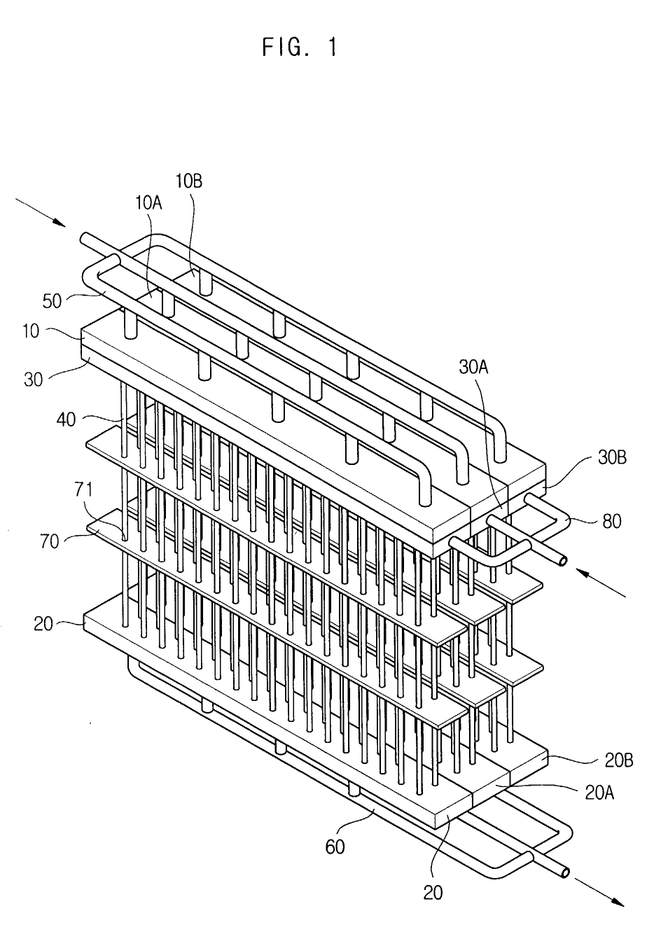

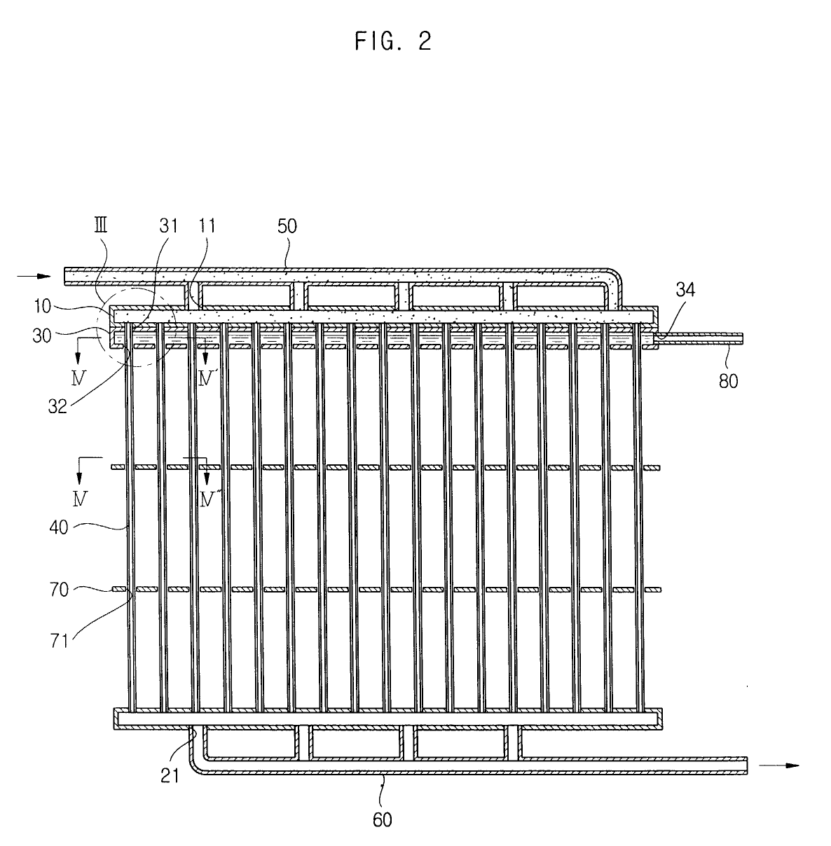

As illustrated in FIGS. 1 and 2, the heat exchanger in accordance with an embodiment of the present invention comprises a channeled upper header 10 which distributes an outlet refrigerant of a compressor (not shown), a plurality of heat exchanging tubes 40 through which the distributed refrigerant flows while transferring heat to the outside of the tubes 40 so as be condensed, and a channeled lower header 20 which gathers the condensed refrigerant flowing from the heat exchanging tubes 40. The heat exchanger also includes a water supply unit 30, which is mounted to the lower surface of the upper header 10 and supplies water to the heat exchanging tubes 40 so as to allow the water to flow down along the external surfaces of the tubes 40.

Each of the upper and lower headers 10 and 20 comprises a channeled body, which has a rectangular cross-section, with a refrigerant channel formed in the body. The channeled body of each of the upper and lower headers 10 and 20 is dosed at both ends thereof. A plurality of refrigerant inlet ports 11 are formed on the upper wall of the upper header 10 and introduce a refrigerant into the interior of the upper header 10. Connected to the refrigerant inlet ports 11 of the upper header 10 is a refrigerant inlet pipe 50 which extends from the refrigerant outlet of the compressor.

The heat exchanging tubes 40 have a circular cross-section and extend in a vertical direction to have a substantial length capable of allowing the refrigerant to transfer heat to water and air around the tubes 40 while the refrigerant flows through the tubes 40. The above heat exchanging tubes 40 are connected to the lower portion of the upper header 10 at the upper ends thereof, and are connected to the upper portion of the lower header 20 at the lower ends thereof. In such a case, the upper and lower ends of the heat exchanging tubes 40 communicate with the interior of the upper and lower headers 10 and 20, respectively. Therefore, the refrigerant is distributed to the heat exchanging tubes 40 by the upper header 10, and flows through the tubes 40 while transferring heat to water and air around the tubes 40, thus being condensed prior to being gathered by the lower header 20. A plurality of refrigerant outlet ports 21 are formed on the lower wall of the lower header 20 and feed the gathered refrigerant from the lower header 20 to a conventional refrigerant-expansion unit (not shown) of a refrigeration system. Connected to the refrigerant outlet ports 21 of the lower header 20 is a refrigerant outlet pipe 60 which extends to the refrigerant-expansion unit.

The water supply unit 30, which is mounted to the lower surface of the upper header 10, comprises a channeled body, which has a hollow rectangular cross-section and defines a water channel. A water supply port 34 is formed at an end of the water supply unit 30. Connected to the water supply port 34 is a water supply pipe 80 which supplies water to the water supply unit 30. A plurality of upper and lower holes 31 and 32 are formed on the upper and lower walls of the water supply unit 30 so as to allow the heat exchanging tubes 40 to perpendicularly pass through the water supply unit 30 through the upper and lower holes 31 and 32.

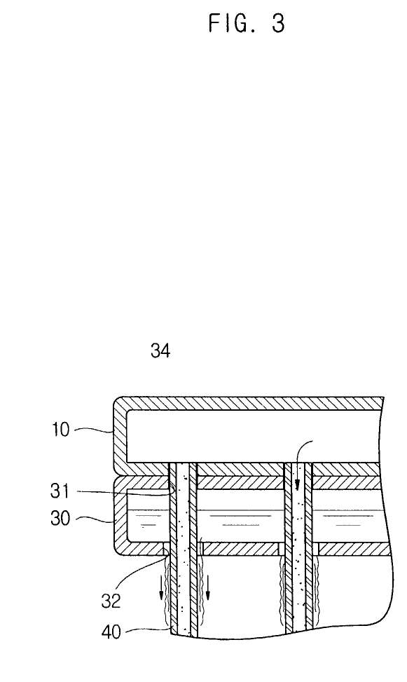

The cross-sectional area of each of the lower holes 32 is larger than that of each of the heat exchanging tubes 40, as illustrated in FIG. 3, thus allowing water from the water supply unit 30 to flow down along the external surfaces of the heat exchanging tubes 40.

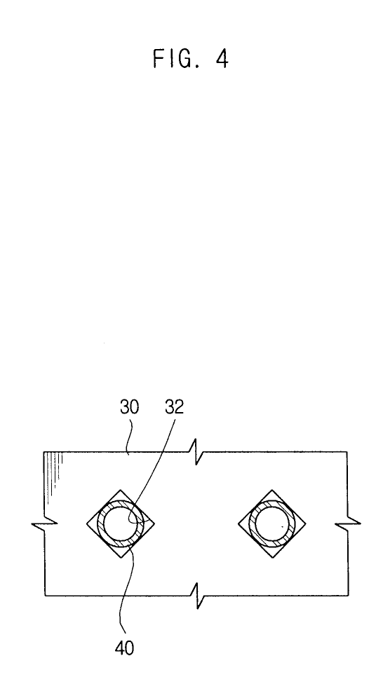

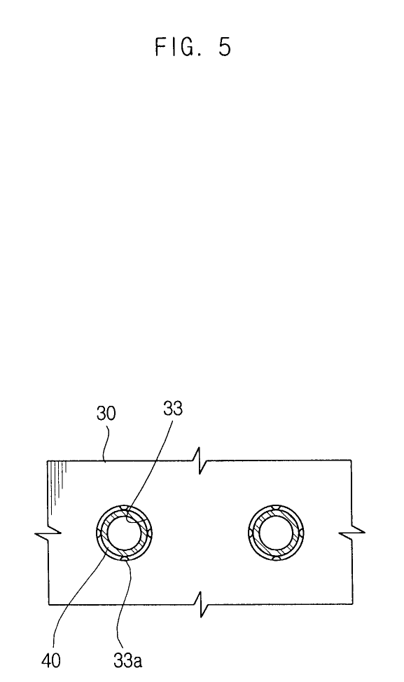

In this embodiment, the lower holes 32 of the water supply unit 30 may have a rectangular shape, as illustrated in FIG. 4, such that the corners of each rectangular lower hole 32 are spaced apart from the external surface of an associated heat exchanging tube 40 and the edges of the rectangular lower hole 32 are in contact with the external surface of the tube 40 at four positions. The lower holes 32 of the water supply unit 30 thus stably hold the heat exchanging tubes 40 without allowing an undesired movement of the tubes 40. Water inside the water supply unit 30 thus leaks from the unit 30 through the gaps between the corners of the lower holes 32 and the external surfaces of the heat exchanging tubes 40, and flows down along the external surfaces of the heat exchanging tubes 40. Of course, it should be understood that the lower holes 32 may be designed to have a triangular, pentagonal or a hexagonal shape in place of the rectangular shape, without affecting the functioning of the present invention. In addition, the lower holes may be designed to have a circular shape, as illustrated in FIG. 5. In such a case, the inner diameter of the circular lower holes 33 is larger than the outer diameter of the heat exchanging tubes 40, and the heat exchanging tubes 40 passing through the circular lower holes 33 are held in the holes 33 by a plurality of support rugs 33a formed along the edge of each circular lower hole 33.

During the process of fabricating the heat exchangers according to this embodiment of the present invention, it is an aspect to design the size and arrangement of the heat exchanging tubes 40, with an inner diameter of about 0.7-2.5 mm, a thickness of about 0.3-1.0 mm, and an interval of about 2-6 mm between neighboring tubes 40.

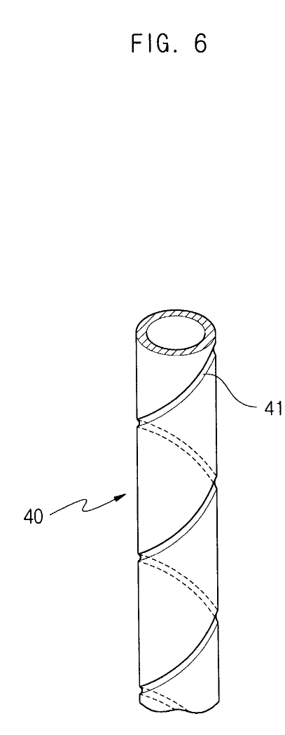

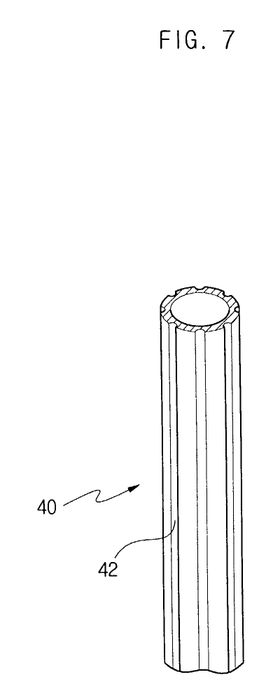

As illustrated in FIGS. 6 and 7, a spiral flow guide 41 or a linear flow guide 42 may be preferably formed on the external surface of each heat exchanging tube 40. The spiral or linear flow guides 41 or 42 of the heat exchanging tubes 40 allow water to evenly flow down along the external surfaces of the tubes 40, and enlarge the heat exchanging surfaces of the tubes 40, thus enhancing heat exchanging efficiency of the tubes 40. In the plural embodiments of the present invention, the spiral flow guide 41 of FIG. 6 may be accomplished by a spiral groove or a spiral ridge formed on the external surface of each heat exchanging tube 40. The linear flow guide 42 of FIG. 7 may be accomplished by a plurality of linear grooves or linear ridges axially extending along the external surface of each heat exchanging tube 40.

In order to prevent an undesired deformation-of the heat exchanging tubes 40 caused by an external shock, a plurality of reinforcing members 70 are assembled with the tubes 40 at positions between the upper and lower headers 10 and 20, as illustrated in FIGS. 1 and 2. Each of the reinforcing members 70 is formed into a flat plate, with a plurality of tube passing holes 71 formed on the plate so as to receive the tubes 40. The tube passing holes 71 of the reinforcing members 70 have a diameter larger than the outer diameter of the tubes 40. That is, the tube passing holes 71 of the reinforcing members 70 are designed in the same manner as that of the upper and lower holes 31 and 32 of the water supply unit 30 so as to hold the heat exchanging tubes 40 and allow water to continuously flow down along the external surfaces of the tubes 40 without being blocked by the reinforcing members 70.

As illustrated in FIG. 1, in an aspect of the present invention, the heat exchanger may include a plurality of upper headers 10, 10A and 10B which have the same construction and are arranged in a parallel arrangement, a plurality of lower headers 20, 20A and 20B which have the same construction and are arranged in a parallel arrangement, and a plurality of water supply units 30, 30A and 30B, which have the same construction and are arranged in a parallel arrangement. A plurality of heat exchanging tubes 40 are parallely arranged between the upper headers 10, 10A and 10B and the lower headers 20, 20A and 20B while being connected to the upper and lower headers, thus creating a set of heat exchanger modules. A plurality of distributing pipes branch from the refrigerant inlet pipe 50, thus forming a distributing manifold. The distributing pipes of the refrigerant inlet pipe 50 are connected to the refrigerant inlet ports 11 of the upper headers 10, 10A and 10B, and distribute the outlet refrigerant of the compressor to the plurality of upper headers 10, 10A and 10B. In the same manner, a plurality of gathering pipes branch from the refrigerant outlet pipe 60, thus forming a gathering manifold. The gathering pipes of the refrigerant outlet pipe 60 are connected to the refrigerant outlet ports 21 of the lower headers 20, 20A and 20B, and gather the condensed refrigerant from the plurality of lower headers 20, 20A and 20B. The water supply pipe 80 also has a water distributing manifold, which is connected to the water supply ports 34 of the plurality of water supply units 30, 30A and 30B, and distributes water into the water supply units 30, 30A and 30B.

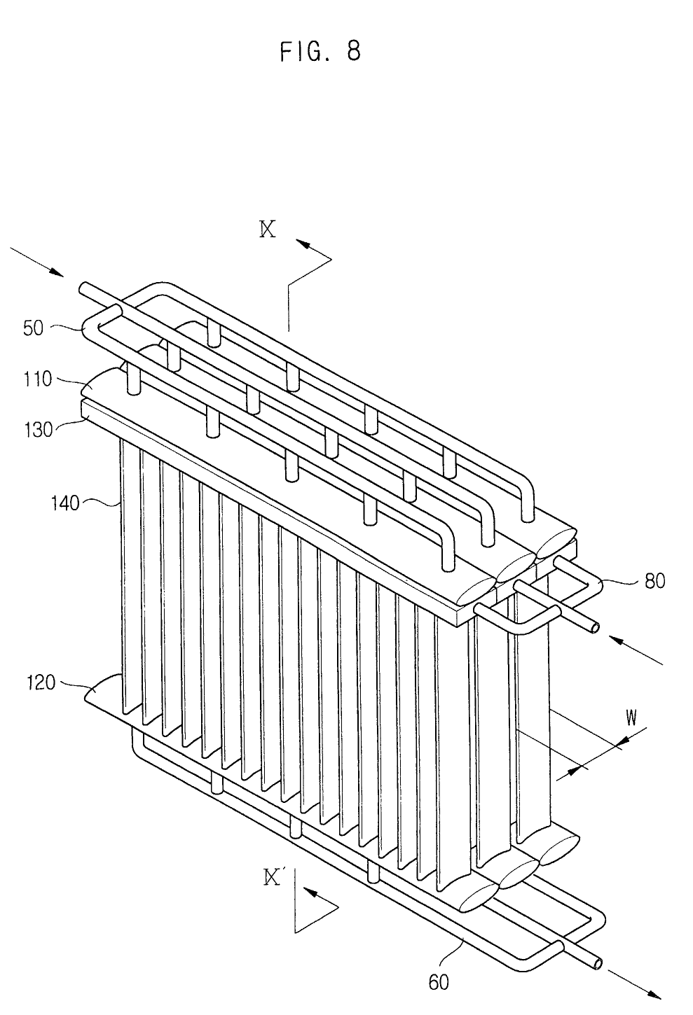

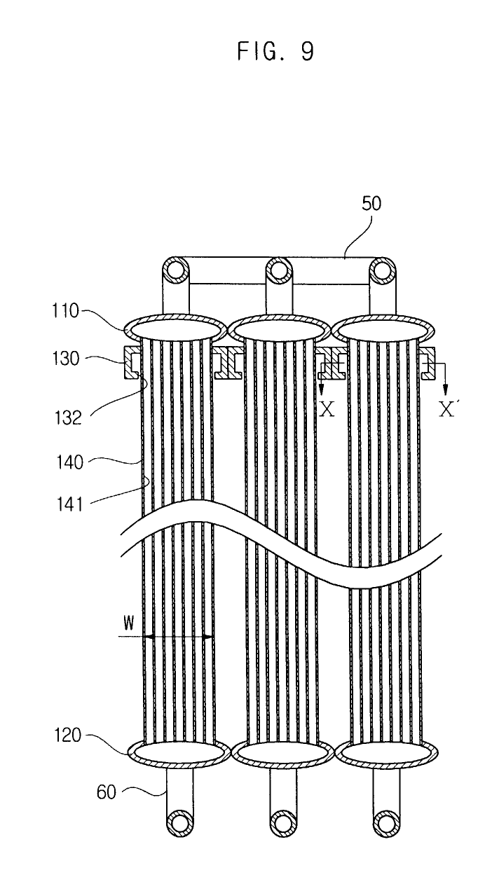

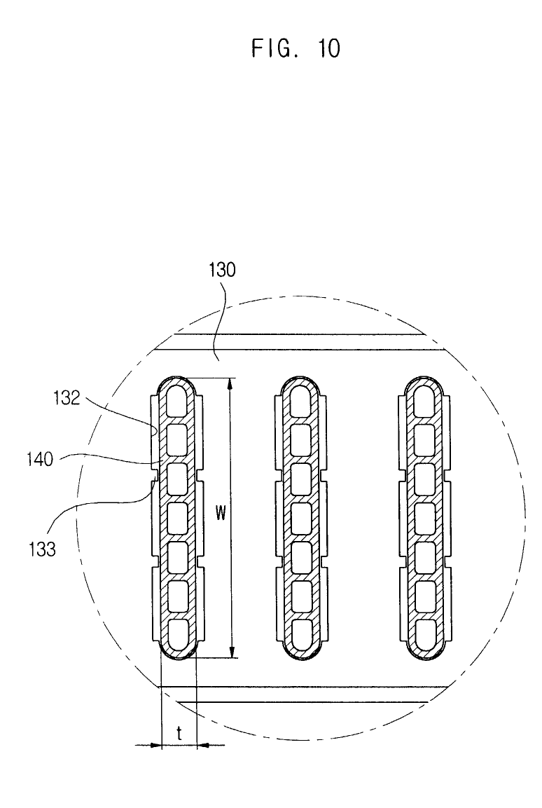

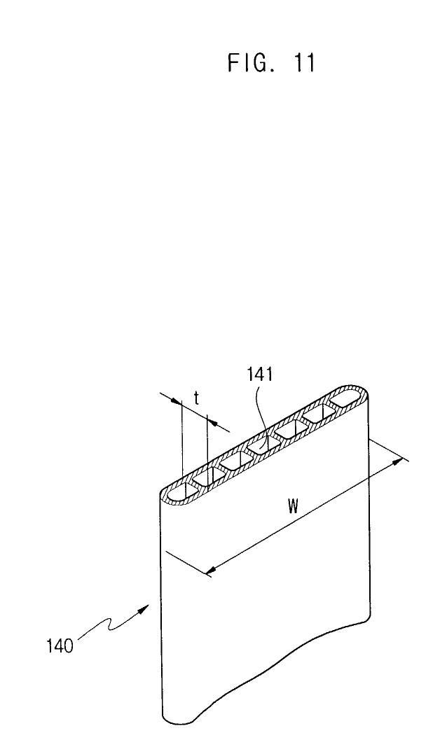

FIG. 8 is a perspective view, illustrating the construction of a heat exchanger in accordance with another embodiment of the present invention. The heat exchanger, according to this embodiment, comprises a plurality of heat exchanging tubes 140 formed as plate-shaped multi-channel tubes, and a plurality of upper and lower headers 110 and 120 formed as a channeled body having an elliptical cross-section. The heat exchanging tubes 140 have a longitudinal flat plate profile, with a predetermined thickness “t” and a predetermined width “w”, as best seen in FIGS. 9 to 11. A plurality of partitioned refrigerant channels 141 are axially formed in each tube 140, so the refrigerant flows through the channels 141.

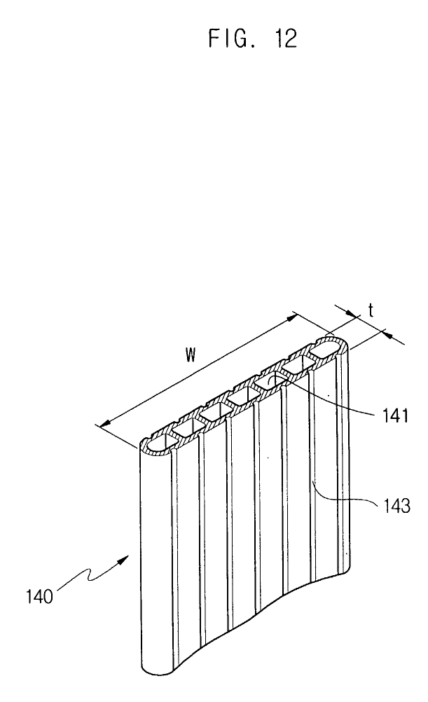

The water supply units 130 are mounted to the lower surfaces of the upper headers 110. The lower holes 132 of the water supply units 130, through which the heat exchanging tubes 140 pass, are designed such that the width of each lower hole 132 is larger than the thickness “t” of the heat exchanging tube 140. Therefore, water of the water supply units 130 leaks from the units 130, and flows down along the external surfaces of the tubes 140. A plurality of support members 133 are formed along the edge of each lower hole 132, and hold a heat exchanging tube 140 passing the lower hole 132. As illustrated in FIG. 12, a linear flow guide 143 may be formed on the external surface of each heat exchanging tube 140. The linear flow guide 143 of the heat exchanging tubes 140 allows water to evenly flow down along the external surfaces of the tubes 140, and enlarges the heat exchanging surfaces of the tubes 140, thus enhancing heat exchanging efficiency of the tubes 140. The linear flow guide 143 may comprise a plurality of linear grooves or linear ridges which axially extend along the external surface of each heat exchanging tube 140.

During the process of fabricating the heat exchangers, according to this embodiment of the present invention, it is preferable to design the size of the heat exchanging tubes 140, with about a 1.5-2.5 mm thickness, about a 5-20 mm width, and about a 1.17-1.52 mm diameter of each refrigerant channel 141.

The operation and effect of the heat exchanger according to the embodiments of the present invention will be described herein below.

During an operation of the heat exchanger, high pressure and high temperature gas refrigerant, which flows from the compressor through the refrigerant inlet pipe 50, is distributed to the heat exchanging tubes 40 or 140 by the upper headers 10 or 110. The distributed refrigerant thus flows to the lower headers 20 or 120 through the tubes 40 or 140 while transferring heat to water and air around the tubes 40 or 140, thus being condensed and changing its gas phase into a liquid phase. The liquid refrigerant from the heat exchanging tubes 40 or 140 is gathered in the lower header 20 or 120, prior to being fed to a conventional refrigerant-expansion unit (not shown) of the refrigeration system through the refrigerant outlet pipe 60.

In such a case, water is fed into the water supply unit 30 or 130 through the water supply pipe 80, and is discharged from the unit 30,130 through the lower holes 32 or 132 of the unit 30 or 130, thus flowing down along the external surfaces of the heat exchanging tubes 40 or 140. The water absorbs heat from the refrigerant while flowing down along the external surfaces of the heat exchanging tubes 40 or 140. In addition, air around the heat exchanger is forced to pass through the gaps between the heat exchanging tubes 40 or 140 by a blower fan (not shown), thus absorbing heat from the tubes 40 or 140. Therefore, the forced air, which passes through the gaps between the heat exchanging tubes 40 or 140, evaporates the water flowing along the external surfaces of the tubes 40 or 140, so the tubes 40 or 140 are quickly cooled due to latent heat of water vaporization. Heat exchanging efficiency of the heat exchanger, according to the embodiment of the present invention, is thus improved in comparison to conventional heat exchangers.

As described above, the present invention provides a water-cooled heat exchanger used for condensing a refrigerant in a refrigeration system. In the heat exchanger, water flows along the external surfaces of a plurality of heat exchanging tubes, so heat transferred from the refrigerant flowing through the tubes is absorbed by both the water flowing along the external surfaces of the tubes and air passing through the gaps between the tubes. In such a case, the refrigerant flowing in the heat exchanging tubes is cooled by latent heat of vaporization of water flowing along the external surfaces of the tubes, so heat exchanging efficiency of the heat exchanger, according to the embodiments of the present invention, is thus remarkably improved in comparison to conventional heat exchangers.

In addition, due to the improved heat exchanging efficiency, it is possible to reduce the size of the heat exchanger, thus reducing the size of a refrigeration system using the heat exchanger.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A heat exchanger, comprising:
an upper header having a refrigerant inlet port and distributing a refrigerant introduced into the upper header through the refrigerant inlet port;
a plurality of heat exchanging tubes connected at upper ends thereof to said upper header and extending in a vertical direction;
a lower header connected to lower ends of said heat exchanging tubes and gathering the refrigerant flowing from the heat exchanging tubes, said lower header having a refrigerant outlet port; and
a water supply unit assembled with upper portions of external surfaces of said heat exchanging tubes, and feeding water to said tubes to cause a flow of water along the external surfaces of said tubes, thus allowing the water to absorb heat from the refrigerant flowing in the heat exchanging tubes.

2. The heat exchanger according to claim 1, wherein said water supply unit comprises a channel which has a water supply port to supply water into the channel, with upper and lower holes formed on upper and lower walls of said water supply unit to allow the heat exchanging tubes to pass through the water supply unit, each of said lower holes having a size larger than that of each of said heat exchanging tubes to allow the water to flow from the water supply unit to the external surfaces of the heat exchanging tubes.

3. The heat exchanger according to claim 2, wherein each of said heat exchanging tubes has a circular cross-section, and each of said lower holes of the water supply unit has a polygonal shape, whereby corners of the polygonal lower holes are spaced apart from the external surface of the heat exchanging tubes and edges of the polygonal lower holes are in contact with the external surfaces of the heat exchanging tubes.

4. The heat exchanger according to claim 2, wherein a plurality of support members are projected from an edge of each of said lower holes toward the external surface of an associated heat exchanging tube, thus spacing the external surface of the heat exchanging tube apart from the edge of the lower hole as well as holding the heat exchanging tube without allowing a movement of the associated heat exchanging tube.

5. The heat exchanger according to claim 1, wherein each of said heat exchanging tubes has a circular cross-section, with a spiral flow guide formed on the external surface of each heat exchanging tube to guide a flow of water.

6. The heat exchanger according to claim 1, wherein each of said heat exchanging tubes has a circular cross-section, with a plurality of linear flow guides axially formed on the external surface of each heat exchanging tube to guide a flow of water.

7. The heat exchanger according to claim 1, wherein each of said heat exchanging tubes has an inner diameter of 0.7-2.5 mm, and a thickness of about 0.3-1.0 mm.

8. The heat exchanger according to claim 1, wherein said heat exchanging tubes are plate-shaped multi-channel tubes, with a plurality of partitioned refrigerant channels axially formed in each of said heat exchanging tubes.

9. The heat exchanger according to claim 8, wherein each of said heat exchanging tubes has 1.5-2.5 mm thickness, 5-20 mm width, and 1.17-1.52 mm diameter of each of said refrigerant channels.

10. The heat exchanger according to claim 8, wherein a plurality of linear flow guides are axially formed on the external surface of each of said heat exchanging tubes to guide a flow of water.

11. The heat exchanger according to claim 1, wherein said upper header, lower header and water supply unit respectively comprise a plurality of upper headers, lower headers, and water supply units, which are dosely arranged in a parallel arrangement, with the heat exchanging tubes being arranged between the upper headers and the lower headers to create a set of heat exchanger modules.

12. The heat exchanger according to claim 11, further comprising:
a refrigerant inlet pipe having a distributing manifold and being connected at the distributing manifold to the refrigerant inlet ports of said upper headers to distribute the refrigerant into the upper headers;
a refrigerant outlet pipe having a gathering manifold and being connected at the gathering manifold to the refrigerant outlet ports of said lower headers to gather the refrigerant from the lower headers; and
a water supply pipe having a water distributing manifold, and being connected to water supply ports of said water supply units to distribute water into the water supply units.

13. The heat exchanger according to claim 1, wherein a plurality of reinforcing members are assembled with the external surfaces of said heater exchanging tubes at positions between the upper and lower headers, to hold the heat exchanging tubes.

14. The heat exchanger according to claim 13, wherein each of said reinforcing members is a flat plate, with a plurality of tube passing holes formed on said plate to receive the heat exchanging tubes, each of said tube passing holes having a size larger than a cross-sectional size of each of the heat exchanging tubes.

15. The heat exchanger according to claim 2, wherein each of said lower holes of the water supply unit has a triangular shape.

16. The heat exchanger according to claim 2, wherein each of said lower holes of the water supply unit has a pentagonal shape.

17. The heat exchanger according to claim 2, wherein each of said lower holes of the water supply unit has a hexagonal shape.

18. The heat exchanger according to claim 2, wherein each of said lower holes of the water supply unit has a rectangular shape.

19. The heat exchanger according to claim 2, wherein each of said lower holes of the water supply unit has a circular shape.

20. The heat exchanger according to claim 5, wherein the spiral flow guides are formed by spiral grooves along the external surface of the heat exchanger.

21. The heat exchanger according to claim 5, wherein the spiral flow guides are formed by spiral ridges along the external surface of the heat exchanger.

22. The heat exchanger according to claim 6, wherein the linear flow guides are formed by linear grooves extending along the external surface of the external surface of the heat exchanger.

23. The heat exchanger according to claim 6, wherein the linear flow guides are formed by linear ridges axially extending along the external surface of the external surface of the heat exchanger.

24. The heat exchanger according to claim 11, wherein the plurality of upper and lower headers are formed of as a channeled body having an elliptical cross-section.

25. A heat exchanger, comprising:
a first header having a refrigerant inlet port and distributing a refrigerant introduced into the first header through the refrigerant inlet port;
a plurality of heat exchanging tubes connected at first ends thereof to said first header and extending therefrom;
a second header connected to second ends of said heat exchanging tubes and gathering the refrigerant flowing from the heat exchanging tubes, said second header having a refrigerant outlet port; and
a water supply unit assembled to contact the first ends of external surfaces of said heat exchanging tubes, and feeding water to said heat exchange tubes to cause a flow of water along the external surfaces of said heat exchange tubes, thus allowing the water to absorb heat from the refrigerant flowing in the tubes.
